(19) United States
(12) Patent Application Publication
(10) Pub. No.: US 2006/0243766 A1
(43) Pub. Date: Nov. 2, 2006

(54) Mobile electronic audio-visual product carrier

(76) Inventor: Jeff Lan, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/117,359

(22) Filed: Apr. 29, 2005

(51) Int. Cl. B60R 7/00

(52) U.S. Cl. 224/275; 224/929

(57) ABSTRACT

A mobile electronic audio-visual (AV) product carrier includes a first container and a second container pivotally turnably connected to a front open side of the first container. The first container is internally provided with a fixing board, to which an electronic AV product may be easily fixed, and has an open-bottomed supporting bag provided at a rear outer side for putting on a headrest of a front seat on a car to hang the mobile carrier to the front seat. The second container is provided with a plurality of pockets for holding compact disks, remote controller, power supply, power cord, etc.

### FIELD OF THE INVENTION

The present invention relates to a mobile electronic audio-visual (AV) product carrier, and more particularly to a mobile carrier that includes multiple layers to orderly contain an electronic AV product and various related accessories therein, and can be hung to a headrest of a front seat on a car for a user to use the electronic AV product without removing the same from the mobile carrier.

### BACKGROUND OF THE INVENTION

Recently, a lot of electronic information and AV products are designed to have small volume, so that they could be carried to different place for use at any time to satisfy people's requirements in leisure activities, including listening musical works. Such electronic products include, for example, notebook computers, tablet computers, personal digital assistants (PDA), portable DVD players, etc. These portable electronic products usually need a bag to hold them, so that the products are well protected and stored to maintain in good condition. However, most conventional bags for holding the compact and portable electronic products do not provide properly separated locations for holding the electronic products and other peripherals and accessories thereof. Users normally arbitrarily position the products and the accessories in the bag. The products and the accessories could not be conveniently taken out of the bag and tend to collide with one another to cause damage of the products. Moreover, the conventional bags for holding portable electronic products are only useful for storing and carrying the products, they do not provide other functions to allow the portable electronic products to be conveniently used in some specific environment, such as allowing a user at a back seat of a car to use the portable electronic AV products without the need of removing them from the bag, so that the electronic products are protected by the bag while they are in use. It is therefore desirable to develop an improved container for electronic AV products to meet people's need in daily life.

### SUMMARY OF THE INVENTION

A primary object of the present invention is to provide a mobile electronic audio-visual (AV) product carrier that can orderly and safely hold an electronic AV product and various accessories thereof, and be hung to a front seat for a user at the back seat to use the electronic AV product on a car without removing the same from the mobile carrier.

To achieve the above and other objects, the mobile electronic AV product carrier according to the present invention includes a first container and a second container pivotally turnably connected to a front side of the first container. The first container is internally provided with a fixing board, to which an AV electronic product may be easily fixed, and has an open-bottomed supporting bag provided at a rear outer side for putting on a headrest of a front seat on a car to hang the mobile carrier to the front seat. The second container is provided with a plurality of pockets for holding compact disks, remote controller, power supply, power cord, etc. The mobile AV electronic product carrier of the present invention is particularly suitable for use on a car to allow a user at a back seat to use the AV electronic product without the need of removing the same from the mobile carrier.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a mobile electronic AV product carrier according to the present invention in a fully closed state;

FIG. 2 is a perspective view of the mobile electronic AV product carrier of the present invention with a first container thereof at an opened position to show a front inner side thereof;

FIG. 3 is a side view of the mobile electronic AV product carrier of the present invention with a back cover behind the first container at an opened position;

FIG. 4 is a perspective view of the mobile electronic AV product carrier of the present invention with a second container thereof in an opened state;

FIG. 5 is a perspective view showing the mobile electronic AV product carrier of the present invention in a fully extended state for use;

FIG. 6 is a fragmentary partially sectioned side view of the mobile electronic AV product carrier of the present invention in use; and

FIG. 7 is a perspective view of an adjusting board included in the present invention.

### DETAILED DESCRIPTION OF THE PREFERRED EMBODIMENTS

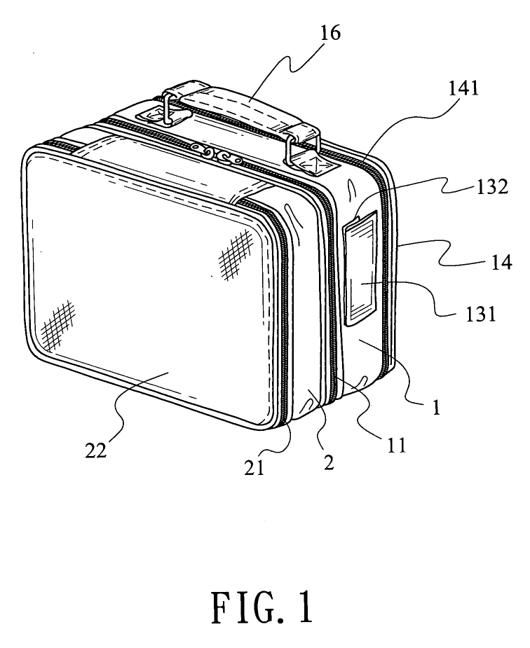

Please refer to FIG. 1 that is a perspective view of a mobile electronic audio-visual (AV) product carrier according to the present invention. For the purpose of conciseness, the present invention is also briefly referred to as the mobile carrier throughout the specification. As shown, the mobile carrier of the present invention includes a first container 1 and a second container 2.

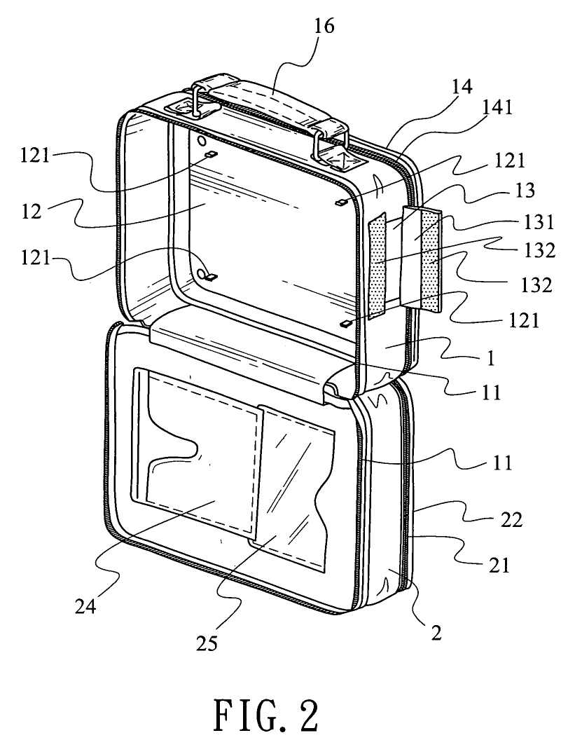

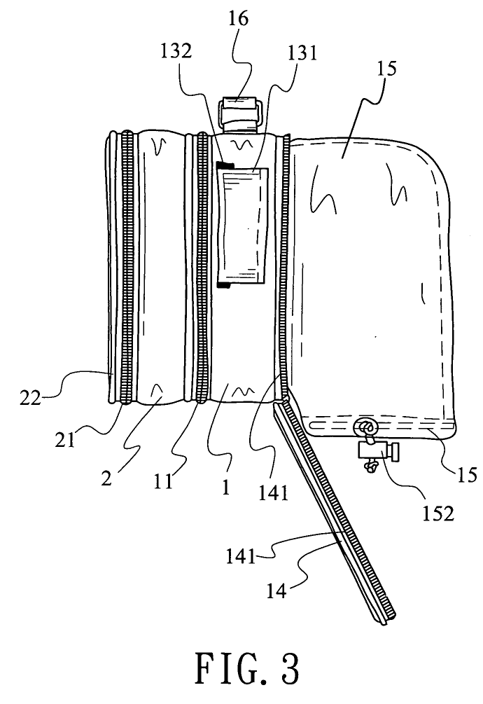

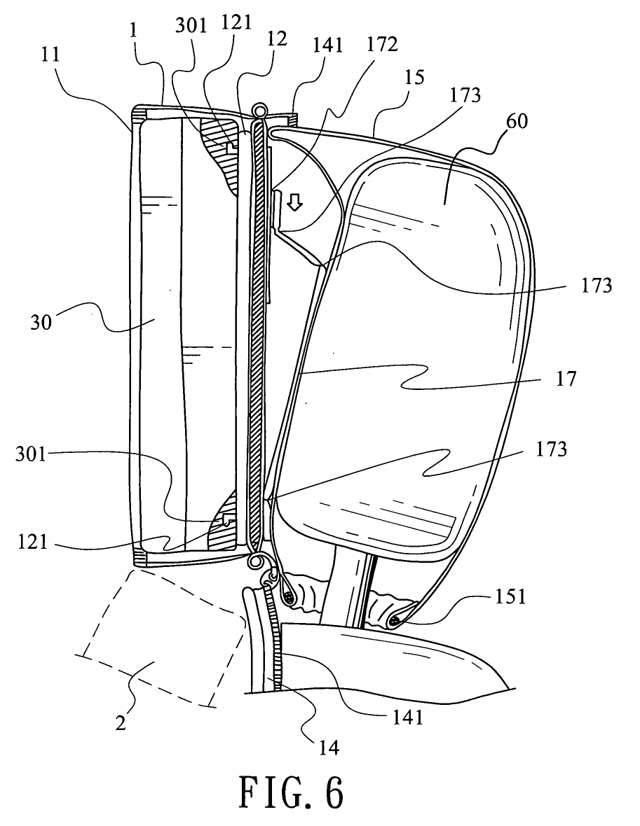

Please refer to FIG. 2 that is a perspective view of the mobile carrier of the present invention with the first container 1 at an opened position to show a front inner side thereof. As shown, the first container 1 is an open-side hollow bag defining a front opening and may be made of fabric, synthetic material, or leather. Along an outer edge of the front opening of the first container 1, there is provided a first zipper 11, via which the first and the second container 1, 2 are connected to each other side by side. A fixing board 12 is provided at the front inner side of the first container 1 and has a plurality of holding members 121 provided thereon. The first container 1 is provided at one lateral side with an opening 13, via which a power cord and other input/output wires may be extended. The opening 13 is openable closed with a pivotally turnable flap 131, which is releasably attached at a free edge to the lateral side of the first container 1 by means of, for example, a magic tape 132 consisting of a hook tape and a loop tape. A back cover 14 is pivotally turnably connected to a rear outer side of the first container 1, and a collapsible supporting bag 15 is received in a space between the first container 1 and the back cover 14. Please refer to FIG. 6. The holding members 121 on the fixing board 12 may be, for example, hooks forward projected from the fixing board 12 to engage with retainers 301 correspondingly formed on a back of an electronic AV product 30 received in the first container 1. The retainers 301 may be customized in the manufacturer's plant, or be affixed to the product 30 latter. The back cover 14 is connected to the rear outer side of the first container 1 via a second zipper 141 extended along an outer edge of the back cover 14, so that the back cover 14 may be opened at any time to stretch open the supporting bag 15. The supporting bag 15 is an open-bottomed bag defining a bottom opening and having a size suitable for putting on a headrest 60 of a front seat. A tying cord 151 is provided along the bottom opening of the supporting bag 15 and has a general adjusting element 152 provided thereon, as shown in FIG. 3, so that the bottom opening of the supporting bag 15 may be tightened against the headrest 60 using the tying cord 151 after the supporting bag 15 has been put on the headrest 60. A handle 16 is provided on a top of the first container 1, as shown in FIG. 1, for a user to carry the mobile carrier conveniently.

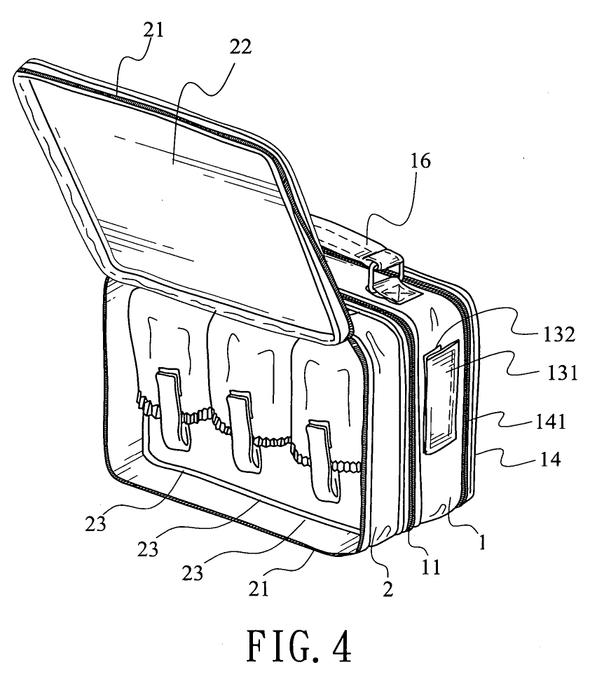

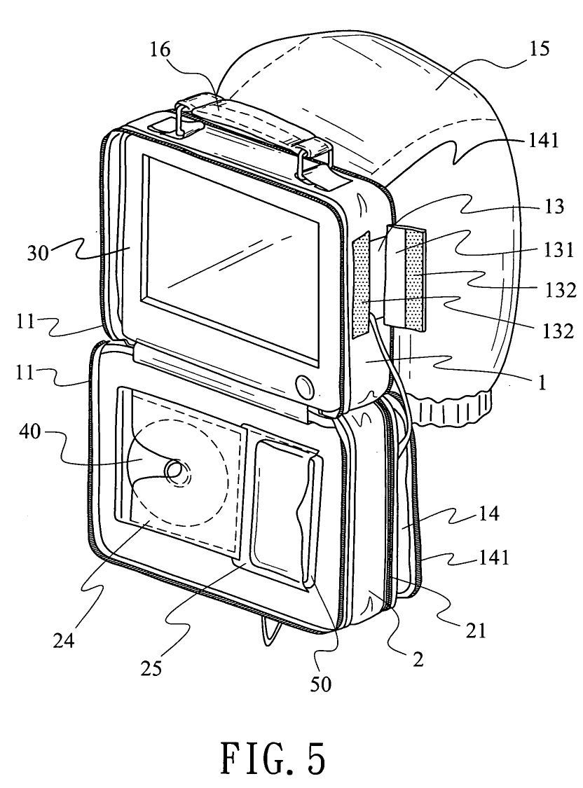

Please refer to FIGS. 1 to 4 at the same time. The second container 2 is also an open-side hollow bag defining a front opening, and may be made of fabric, synthetic material, or leather. A front cover 22 is pivotally turnably connected to the front opening of the second container 2 via a third zipper 21 extended along an outer edge of the front opening of the second container 2. As can be most clearly seen from FIG. 4, the second container 2 is provided on a front inner side with a plurality of pockets 23 for holding a power supply and other accessories therein. And, as can be seen from FIGS. 2 and 5, the second container 2 is provided on a rear side with a compact disk pocket 24 and a miscellaneous pocket 25 for holding compact disks 40 and a remote controller 50 therein, respectively. The second container 2 is connected at a rear edge to an edge of the front opening of the first container 1, and is openably closed to the front opening of the first container 1 via the first-zipper 11.

In practical use of the mobile carrier of the present invention, the electronic AV product 30 may be fixed to the fixing board 12 in the first container 1, and many other necessary accessories, such as power cords, AV lines, power supply, compact disks, remote controller, etc., may be orderly positioned in the pockets 23, 24, 25 provided on the front and the rear side of the second container 2. Moreover, as shown in FIGS. 5 and 6, the back cover 14 may be zipped open and pivotally turned to expose the supporting bag 15, so that the supporting bag 15 can be stretched open and put on the headrest 60 of a front seat on a car. In this manner, the whole mobile carrier may be hung on the headrest 60, and the first and the third zipper 11, 21 may be opened to expose the electronic AV product 30, the compact disk pocket 24 and the compact disks 40, as well as the miscellaneous pocket 25 and the remote controller 50 for users at back seats to conveniently use the electronic AV product 30 on the car without the need of removing the electronic AV product 30, the compact disks 40, and the power cord and AV lines from the mobile carrier.

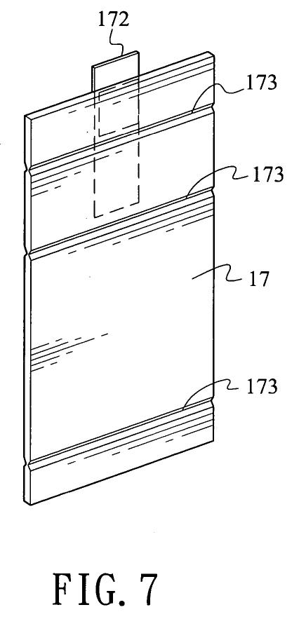

Please refer to FIG. 6. An adjusting board 17 may be provided between the first container 1 and the supporting bag 15. The adjusting board 17 has a lower end fixedly connected to a rear lower edge of the first container 1, and an upper end adjustably connected to a rear upper part of the first container 1 by means of a magic tape 172, a hook tape of which is attached to the rear outer side of the first container 1, and a loop tape of which is attached to an upper inner end of the adjusting board 17 facing toward the first container 1. As can be seen from FIG. 7, the adjusting board 17 is provided on two opposite surfaces with a plurality of corresponding folding sections 173 differently spaced from one another. When the headrest 60 is inclined by a certain angle, as shown in FIG. 6, the upper end of the adjusting board 17 may be adjusted to a lower position to attach the hoop tape of the magic tape 172 to the hook tape fixedly attached to the rear outer side of the first container 1, so that the adjusting board 17 is bent at the folding sections 173 to always support the first container 1 and accordingly the electronic AV product 30 therein in a vertical position in front of the user.

What is claimed is:

1. A mobile electronic audio-visual product carrier, comprising a first and a second container, said mobile carrier being characterized in that:
said first container defines a front opening, around an outer edge of which there is provided a first zipper to connect said first container to an outer edge of a rear side of said second container, and said first container is provided on a front inner side with a fixing board, on which a plurality of holding members are provided, and on a rear outer side with a pivotally turnable back cover to receive a collapsible supporting bag in a space between said first container and said back cover; and that
said second container defines a front opening, around an outer edge of which there is provided another zipper to connect said second container to an outer edge of a front cover, so that said front cover may be zipped open and pivotally turned to expose said front opening of said second container; and said second container is connected at a rear edge to the outer edge of said front opening of said first container, so as to openably close said front opening of said first container via said first zipper.

2. The mobile electronic audio-visual product carrier as claimed in claim 1, wherein said first container is provided at one lateral side with an opening, which is openably closed by a pivotally turnable flap; and said flap being releasably attached at a free edge to the lateral side of said first container by means of a magic tape.

3. The mobile electronic audio-visual product carrier as claimed in claim 1, wherein said back cover is openably closed to said rear outer side of said first container via a zipper provided along an outer edge of said back cover; and wherein said supporting bag is an open-bottomed bag defining a bottom opening and having a size suitable for putting on a headrest of a front seat on a car, said bottom opening of said supporting bag being provided with a tying cord, on which an adjusting element is provided.

4. The mobile electronic audio-visual product carrier as claimed in claim 1, wherein said second container is provided on a front inner side with a plurality of pockets, and on a rear side with a compact disk pocket and a miscellaneous pocket.
